(19) United States
(12) Patent Application Publication
(10) Pub. No.: US 2008/0064393 A1
(43) Pub. Date: Mar. 13, 2008

(54) Managing Multimode Roaming Mobile Devices

(76) Inventors: Paul Oommen, San Jose, CA (US); Mitch Tseng, Plano, TX (US)

Correspondence Address: MORGAN & FINNEGAN, L.L.P., 3 WORLD FINANCIAL CENTER, NEW YORK, NY, 10281-2101, US

(21) Appl. No.: 11/597,646

(22) PCT Filed: May 26, 2005
(86) PCT No.: PCT/IB05/02296

§ 371 Date: Sep. 19, 2007

Related U.S. Application Data
(60) Provisional application No. 60/575,592, filed on May 27, 2004.

(51) Int. Cl. H04Q 7/20

(52) U.S. Cl. 455/432.1

(57) ABSTRACT

A mobile device for roaming between wireless communications networks in different geographical regions, the mobile device comprising a radio interface configured to receive network data over a wireless channel, said data relating to one or more of a plurality of access technologies available in a geographical region, a first store holding channel acquisition data relating to each of said plurality of access technologies for setting up a communication mode in a selected one of said access technologies, a second store holding a plurality of access technology selection parameters, and a multimode overlay function component configured to evaluate said data and select one of said access technologies based on at least one of said selection parameters.

### CLAIM OF PRIORITY FROM COPENDING PROVISIONAL PATENT APPLICATION

This patent application claims priority under 35 U.S.C. '119(e) from Provisional Patent Application No. 60/575,592, filed May 27, 2004, the disclosure of which is incorporated by reference herein in its entirety.

### FIELD

Embodiments of the invention relate in general to over the air (OTA) device management and particularly to managing multimode roaming mobile devices.

### BACKGROUND

Service providers set up roaming agreements with other service providers in different geographic regions so that when the user is in a region where the home service provider does not offer a service, nevertheless the service can be provided by a different service provider who has a billing arrangement with the home service provider. Any particular region may support different systems and networks. For CDMA (Code Division Multiplex Access) networks, a Preferred Roaming List PRL which is stored at the mobile device provides information about which system/network is preferred in the region for that device. Over-the-air (OTA) Management protocols allow data to be transmitted to mobile devices via wireless transmission media. One example of OTA Device Management (DM) is the re-programming of the Preferred Roaming List (PRL). In CDMA (IS-95 systems and cdma2000 family of systems), when a mobile user is abroad and switches on the mobile device for the first time, the mobile device performs a search for all available networks subject to the conditions in the PRL. The mobile device then reads from the PRL the preferred networks and the order in which they should be offered to the user. Since preferred networks are constantly changing as new roaming agreements are made, it is necessary to frequently update the PRL in the mobile device. This is achieved by downloading the revised PRL remotely using OTA technology. OTA protocols are defined for example in the over-the-air service provisioning/parameter administration (OTASP/OTAPA) and Open Mobile Alliance (OMA) device management standards. See 3GPP2 C.S0016 Over-the-Air Service Provisioning of Mobile Stations in Spread Spectrum Systems, 3GPP2, March 2003 http://3gpp2.org/Public_html/specs/index.cfm In GSM systems, a PLMN selection procedure is defined in 3GPP standards for the MS to select a home or preferred network when roaming.

Current protocols developed in OMA (Open Mobile Alliance) DM provide an integrated framework for OTA management of 3G mobile devices. See OMA Device Management Protocol, version 1.1.2, OMA, Jun. 12, 2003. http://www.openmobilealliance.org/release_program/enabler_releases.html, and 3GPP2 C.S0040 IP Based Over-the-Air configuration management, version 1.0. http:3gpp2.org/Public_html/specs/C.S0040-0_v1.0_{—}110403.pdf

The existing OMA DM protocol defines a management framework and a set of messages exchanged between one mobile device and an entity in the network called the management server. A management session is set up between the management server and the mobile device, and an OTA message is constructed which is unique to the mobile device.

FIG. 1 illustrates the structure of a preferred roaming list PRL for CDMA networks. There is a system table ST₁ . . . STᵢ . . . STₙ associated with each geographical region which contains a list of system descriptions keyed by system identifier/network identifier (SIN/NID) pairs and associated with an acquisition index. The acquisition index is used as a pointer to an acquisition table AT which contains an indexed list of RF channels for channel acquisition purposes in the new network.

According to the current standard, system acquisition can be carried out using frequency blocks with PCS assigned values, or by using channel numbers with the highest priority channel first.

To date preferred roaming lists are provided only in the context of CDMA operation, which includes system selection in analogue mode and CDMA mode.

Currently, for GSM mobile equipment, a list of preferred Public Land Mobile Networks (PLMNs) is stored in the Subscriber Identity Module (SIM) of the mobile device. The Removable User Identity Module (R-UIM) standard defines how the PRL is managed in devices supporting R-UIM. This enables roaming through PLMN selection when the mobile equipment is outside the home network. However, a GSM mobile device would have no information about a CDMA network in its geographical region or vice-versa.

So-called multimode devices are currently being developed which should be capable of roaming in heterogeneous network environments. For example, a device originally provisioned in a CDMA network should be capable of roaming in a GSM, WLAN (Wide Local Area Network), UMTS (Universal Mobile Telecommunications Systems) or networks of any other access systems. An access system in this context means a mobile and wireless communication system based on an air interface technology.

### SUMMARY

There exists a need therefore to improve the management of access technology selection for multimode roaming, between existing access technologies and possible future access technologies.

According to one aspect of the invention there is provided a mobile device for roaming between wireless communications networks in different geographical regions, the mobile device comprising: a radio interface configured to receive network data over a wireless channel, said data relating to one or more of a plurality of access technologies available in a geographical region; a first store holding channel acquisition data relating to each of said plurality of access technologies for setting up a communication mode in a selected one of said access technologies; a second store holding a plurality of access technology selection parameters and a multimode overlay function component configured to evaluate said data and select one of said access technologies based on at least one of said selection parameters.

The access technology selection parameters can include parameters for the said plurality of access technologies supported in the mobile device.

Another aspect of the invention provides a method of selecting a communication mode for a mobile device roaming between wireless communications networks in different geographical regions, the method comprising the steps of: receiving network data identifying wireless communications networks in a region where the mobile device is located; accessing at least one access technology selection parameter stored at the mobile device; implementing at the mobile device a multimode overlay function to select one of a plurality of access technologies based on said at least one access technology selection parameter and said network data; and scanning channel acquisition data for the selected access technology to set up a communication mode using the selected access technology.

A further aspect of the invention provides a method of managing access technology selection in a mobile device capable of transmitting and receiving signals using each of a plurality of access technologies, the method comprising: transmitting a notification message from a mobile device to a management server, said notification message including parameters identifying the device and an access technology of a current communication mode; and transmitting an update message from the management server to the mobile device according to said communication mode, for performing an update to at least one access technology selection parameter stored at the mobile device.

A different aspect of the invention provides a method of managing an access technology selection in a mobile device capable of transmitting and receiving signals using each of a plurality of access technologies, the method comprising: transmitting a notification message from a mobile device to a management server, said notification message including parameters identifying the device and an access technology of a current communication mode; and transmitting an update message from the management server to the mobile device according to said communication mode, for performing an update to at least one algorithm implemented in a multimode overlay function component stored at the mobile device.

Another aspect of the invention provides a computer program product comprising a code sequence which, when executed by a processor in a mobile device, carries out the following steps: receiving network data identifying wireless communications networks in a region where the mobile device is located; accessing at least one access technology selection parameter stored at the mobile device; and implementing an access technology selection algorithm for selecting one of a plurality of access technologies based on said at least one access technology selection parameter and said network data.

A system according to an embodiment of this invention provides an overlay function and a method for managing overlay function in order to achieve efficient multimode roaming.

Embodiments of the invention provide a multimode roaming overlay function, which is used for managing multimode roaming in heterogeneous networks. The multimode roaming overlay function is linked to the operating software (radio software) of the mobile station, parameter block used by the multimode roaming function, and preferred lists of systems and channels for each access system. Embodiments of the invention also provide a mechanism to upload and download the information (e.g. parameters linked to the multimode roaming overlay function, which helps in controlling access system selection).

The multimode overlay function and a method for remotely managing it over-the-air enables multimode roaming in heterogeneous networks involving GSM, CDMA, WLAN and other future access technologies, supported by the terminal. One example of multimode access terminal is CDMA-GSM dual-mode or any terminal consisting of two or more, but not limited to the list, of the following access technologies: CDMA, GSM, GPRS, CDMA, HRPD, EDGE, WLAN.

In multimode systems, a complex situation exists. The algorithm or rules implemented in the multimode roaming function can be used to decide when to switch between GSM and CDMA systems when the mobile station is in a region where both systems overlap. It may be difficult to standardize such an algorithm. This means that there should be a way to update the code and parameters corresponding to the multimode overlay function. Thus in one embodiment changes or improvements to the algorithm can be updated to the mobile station towards effective system selection in multimode environment. This multimode overlay function can be updated independent of the preferred PLMN or and PRL lists.

In hybrid networks involving WLAN and other future access technologies, the multimode overlay function may include functions for searching and system selection for each access technology supported by the mobile station.

In a possible embodiment of the invention, the mobile station has a common module (which may be called multimode overlay function), which is used for managing multimode roaming, and system selection and linked to the operating software (radio software) of the mobile station, parameters used by the multimode overlay function, and preferred lists of systems and channels for each available access technology.

In a possible embodiment of the invention the multimode overlay function includes the logic or algorithm to decide when and how to switch to a different mode of operations and select a new radio access.

In a possible embodiment of the invention, the multimode overlay function and associated parameters can be remotely managed using over-the-air methods. This includes updating parameter values, such as thresholds to be used to determine the time to switch systems by the multimode overlay function logic.

In a possible embodiment of the invention, the priority and the software codes of the multimode overlay function can be changed over-the-air, such as when there are changes (or improvements) to the algorithm used for radio access selection (for example, the algorithm for deciding when to switch to CDMA mode, when the mobile is currently operating in GSM mode).

In a possible embodiment of the invention, the multimode overlay function includes functions for selecting between CDMA, GSM, Wireless LAN (WLAN), and any future access technologies.

In a possible embodiment of the invention, the multimode overlay function can be part of the mobile phone operating software.

In a possible embodiment of the invention, the multimode overlay function can be separate from the radio software, but located in the mobile equipment.

In a possible embodiment of the invention, the multimode overlay function and the associated parameter block can be located in the SIM/R-UIM card.

In a possible embodiment of the invention, the multimode overlay function and associated parameter block can be located in the SIM/R-UIM card or future extensions of SIM/R-UIM.

In a possible embodiment of the invention, there are preferred roaming list of systems and channels for each access technology.

In a possible embodiment of the invention, the radio software is linked to the preferred roaming lists. The radio software uses the preferred list to select a system (or a network) and acquire a radio frequency.

In a possible embodiment of the invention, the preferred list for each access technology is located in the SIM/R-UIM card or future extensions of SIM/R-UIM.

In a possible embodiment of the invention, the OTA method used for remotely managing the multimode roaming function, associated parameter blocks and preferred lists may be the OTASP/OTAPA (IS-683/3GPP2 C.S0016 and its improvements) used for CDMA systems.

In a possible embodiment of the invention, the OTA method used for remotely managing the multimode roaming function, associated parameter blocks and preferred lists may be the IOTA-HCM (3GPP2 C.S0040 and its improvements) used for CDMA systems.

In a possible embodiment of the invention, the OTA method used for remotely managing the multimode roaming function, associated parameter blocks and preferred lists may be Device Management Protocol defined by Open Mobile Alliance (OMA DM) and it improvements.

In a possible embodiment of the invention, the OTA method used for remotely managing the multimode roaming function, associated parameter blocks and preferred lists may be XML based Protocols.

In a possible embodiment of the invention, the OTA method used for remotely managing the multimode roaming function, associated parameter blocks and preferred lists may be SMS based Protocols.

In a possible embodiment of the invention, various preferred lists, the multimode overlay parameter block and the multimode overlay function can be represented using a hierarchical management tree for the purpose of OTA management using Device Management mechanism.

In a possible embodiment of the invention, there can be additional security mechanism for managing preferred lists, multimode parameter block and the multimode overlay function. The security may be defined such that the preferred list for GSM cannot be changed when operating in the CDMA mode, similarly for other lists. The security can be defined also to allow managing CDMA parameters even when operating in GSM mode. One of the existing security mechanisms of newly defined security methods can be employed for the security of managing various preferred lists, multimode parameter block and multimode overlay function.

In a possible embodiment of the invention, the user is able to start the management process, so that a new version of multimode function and associated parameters and preferred lists can be obtained.

In a possible embodiment of the invention, the network is able to start the management process.

For a better understanding of the present invention and to show how the same may be carried into effect, reference will now be made by way of example to the accompanying drawings.

### BRIEF DESCRIPTION OF THE DRAWINGS

FIG. 1 is a schematic diagram of an existing preferred roaming list;

FIG. 2 is a schematic diagram illustrating a roaming mobile device;

FIG. 3 is a schematic diagram illustrating the architecture of a mobile device in accordance with one embodiment of the invention;

FIG. 4 is a schematic diagram illustrating the architecture of a mobile device including an OTA management client; and

FIG. 5 is a schematic diagram illustrating OTA management.

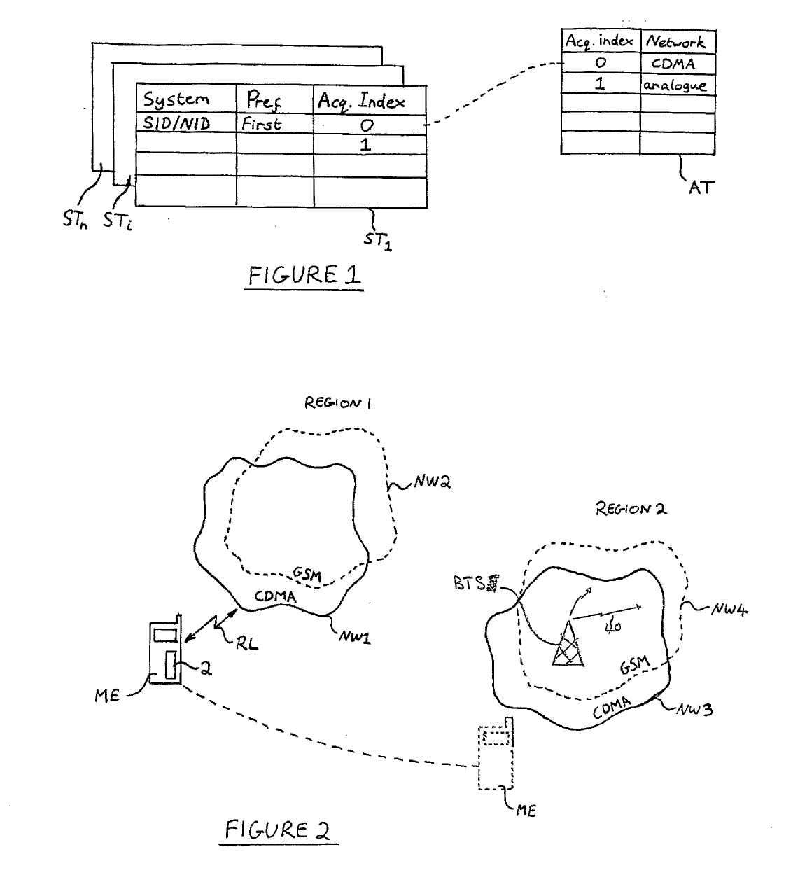

### DESCRIPTION OF THE PREFERRED EMBODIMENTS

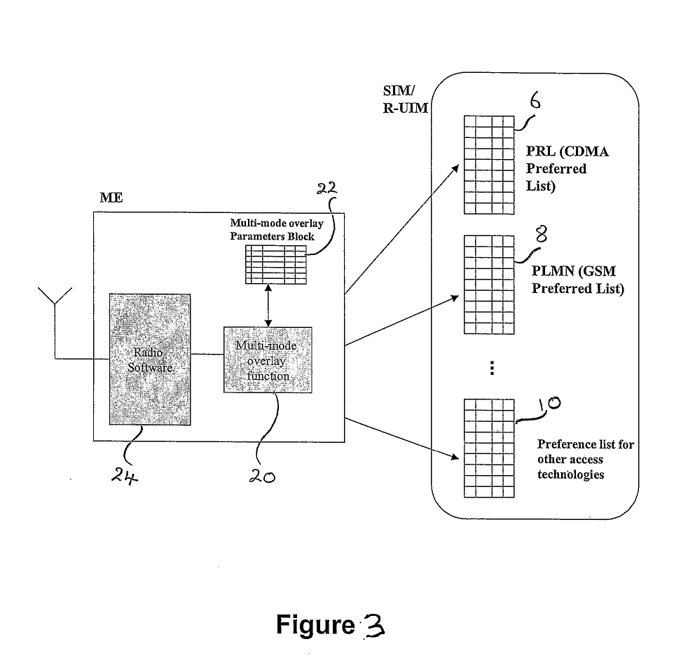

FIG. 2 is a schematic diagram illustrating the principle of a user roaming between networks. A mobile device is referred to in the following as a mobile equipment ME and is illustrated located in a first region, Region 1 and in communication with a first network NW1 over a radio link RL. As is well know, the radio link constitutes a physical signalling channel over the air interface between the mobile equipment ME and the network. In this case, the network that the mobile equipment ME is in communication with is a CDMA (Code Division Multiplex Access) network, and the communication mode for the radio link is CDMA. However, the Region 1 also supports a second network NW2, which in the illustrated case is a GSM network. So-called multimode mobile devices can operate using different access technologies such as CDMA, GSM, WLAN, UMTS etc. To this end, they are provided with a wireless interface for receiving and transmitting signals according to each of a plurality of different access technologies supported by appropriate client software operating in the mobile equipment. Different geographical regions can provide one or more networks or systems of different access technologies, though in any particular region it is likely that one of the networks or systems will be preferred.

When the mobile equipment ME moves to a second region, Region 2, that region similarly provides more than one network with different access technologies (NW3-CDMA, NW4-GSM). In Region 2, the mobile equipment ME needs to determine which would be the preferred access technology for that particular region.

As is well known, the mobile equipment includes a memory 2. Amongst other things, the memory 2 stores a preferred roaming list PRL. In some types of mobile equipment ME, a replaceable user identity module (R-UIM) is used to store the preferred roaming list PRL instead of the memory 2. Although in many cases the mobile equipment is a mobile telephone, it will be appreciated that other types of mobile equipment can be utilized, in particular a mobile computer.

FIG. 3 illustrates the structure of the preferred roaming list which is stored at the mobile equipment ME and components for managing selection of an access technology.

The PRL illustrated in FIG. 3 has a set of access technology specific PRL blocks including a CDMA PRL block 6, a GSM PRL (PLMN) block 8, and a PRL block 10 for other access technologies. The Preferred Roaming List (PRL) is used in CDMA mobile devices for selecting preferred system and acquiring channel when the user is roaming. PRL defines system, network and channel preferences in order of priority. In GSM, a list of preferred PLMNs are stored in the SIM. This enables roaming through PLMN selection when the mobile is outside the home PLMN, through selecting preferred PLMN in the visited region. Each of the individual access technology specific blocks 6, 8, 10 includes channel acquisition data for use by the mobile equipment ME in setting up a radio link for communication in that particular region via the selected access technology.

PRL and PLMN list are static data blocks, which can be stored either in a non-volatile memory of the Mobile Equipment (ME) or the R-UIM/SIM card. There can be PRL for WLAN and other access technologies, also stored in a similar way. For WLAN system selection, the list preferences may not be called PRL or PLMN, but can be a new parameter block with a name defined in future standards. Similarly for other future access technologies also there can be parameter blocks with the functionality of PRL or PLMN.

Initial provisioning of the PRL in the home network can be done using Internet Protocol (IP) based over-the-air device management (IOTA-DM) or over-the-air service provisioning/parameter administration (OTASP/OTAPA) protocols, depending on the chosen method and in particular whether the data is to be supplied via an IP-based protocol in data bursts or using pure air-interface signalling in the home network. Alternatively, initial provisioning can be implemented through the manufacturing or distribution process by placing roaming information and parameters onto devices such as SIM cards or R-UIMs at the time of manufacture. The preferred lists for various access technologies (PRL for CDMA, PLMN for GSM and preference list for other access technologies) can be updated using OTA methods. OTA methods can be IS-683 OTASP/OTAPA (and its later revisions), OMA Device Management (and its later revisions) or any other OTA technology capable of managing mobile station data in a secure way.

FIG. 3 also illustrates a multimode overlay function block 20 linked to a multimode roaming parameter block 22, the preferred roaming lists (PRL) for various access technologies, and a radio software component 24 in accordance with an embodiment of the invention.

The overlay function block 20 selects the system for the ME multimode terminal to operate on. For example, if the preferred mode for the multimode terminal is CDMA but CDMA service is not available in a region, the overlay function can instruct the terminal to select the next preferred access technology and available system, which can be either a GSM system or WLAN, or any other technology.

When the mobile station is operating in one mode, it may be able to do a background search for the presence of another access technology/system. The algorithm or rules for searching for an access system are implemented in the multimode overlay function block 20. One such rule can be on how frequently the terminal should search for an access system, in order to improve the efficiency of the battery life. The set of rules kept in the overlay function 20 can be updated in the mobile device or uploaded to the network. It can be downloaded to the device memory or R-UIM/SIM or future smart card technologies through an OTA managing method. Changes or improvements to the algorithm can be updated to the mobile equipment towards effective system selection in multimode environment. The code and parameters corresponding to the multimode overlay function can be updated independently of the preferred PRL and/or PLMN lists.

The radio software component 24 interfaces to the multimode overlay function block 20 as shown in FIG. 3. The multimode overlay function block 20 outputs results to the radio software component 24, enabling the searching of preferred access technologies based on parameters specified in the multimode roaming parameter block 22. This means that the radio software is also linked to the PRLs.

The multimode roaming parameter block 22 holds parameters which the overlay function uses in the algorithm/rules to decide about selecting an access technology. The parameters can include the timing of searches for each access technology, as well as threshold values to be used by algorithms for system selection implemented in the overlay function block 20. For example, when GSM and CDMA services overlap in a region, the multimode roaming overlay function 20 (based on parameters in the parameter block 22) and network data such as measurements of signal strength (strength of signal received on a beacon frequency in GSM or the received signal strength (RSSI) in CDMA), can decide whether to select the GSM or CDMA system in the given region. The system selection decision made by the multimode overlay function causes the radio software component 24 to initiate the process of acquiring a preferred channel in the selected access technology and system.

The multimode overlay function can be integrated in the radio software component 24. It can be also implemented as a separate software module as shown in FIG. 3. In both cases the upgrades or modifications to the multimode overlay function can be managed using OTA methods. There are several methods of OTA software updates, such as OMA Download, Firmware OTA (FOTA), plain FTP or any other technology for updating mobile station software in a secure way.

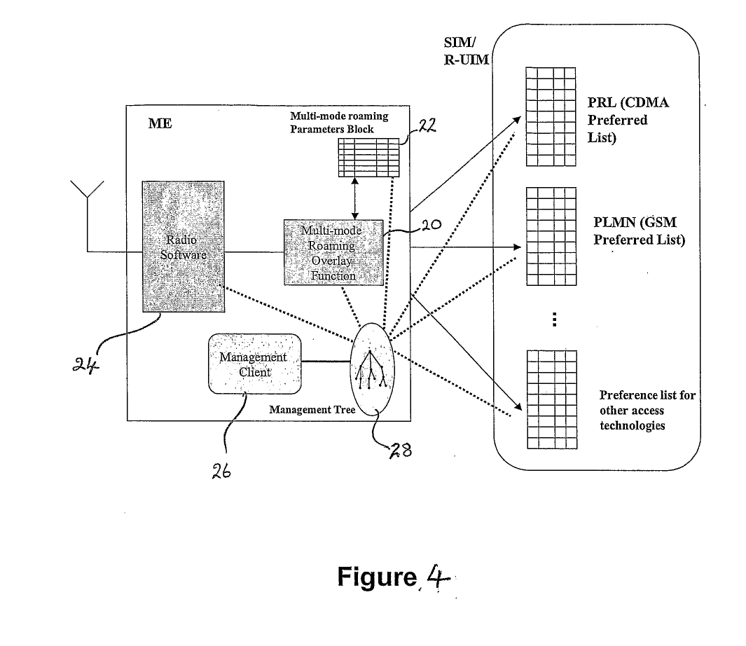

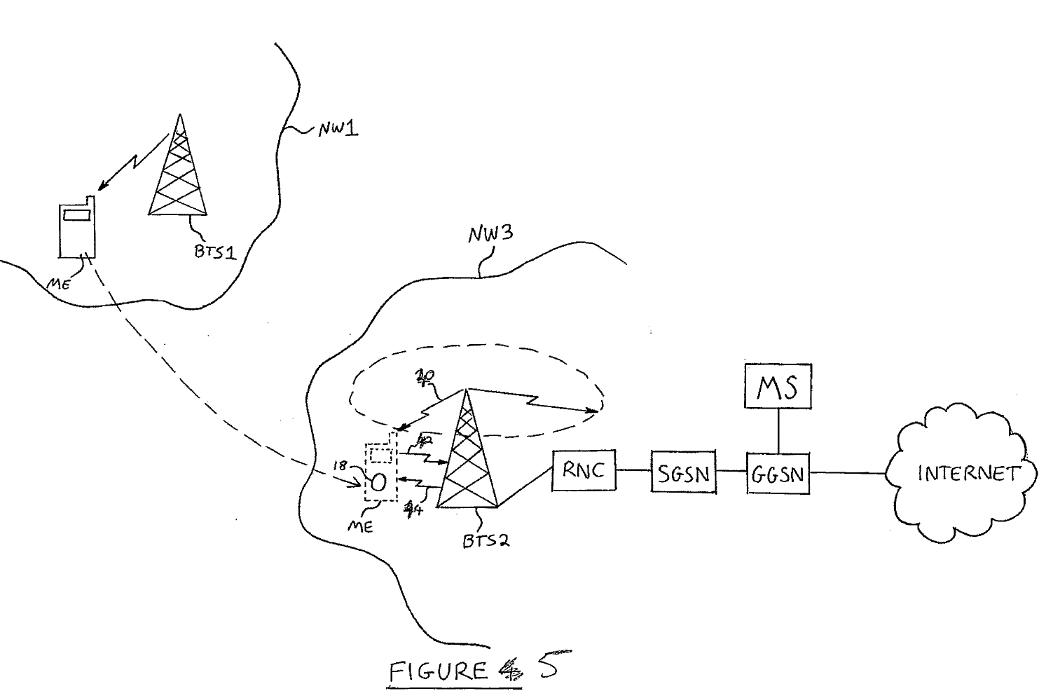

FIG. 4 shows an OTA management client 26 linked to the multimode overlay function block 20, the radio software component 24 and various parameter blocks 22, including the preferred lists, via a management tree structure 28.

The management client 26 is used for OTA management of multimode roaming. Various parameter blocks and the multimode roaming function may be abstracted using the hierarchical management tree structure 28 for the purpose of OTA management using the Device Management protocol.

Operation of the multimode overlay function when a user roams between networks will now be described. In GSM systems and its evolution, the cell selection is done through measuring the level of the signal received by the mobile station on the beacon frequency. There is an algorithm specified for deciding when to switch from one cell to another, when the mobile station is in a region where coverage of both cells overlap. The algorithm is based on signal strength on the beacon frequency of both cells and certain threshold values. In CDMA systems, valid pilot channel is searched for channel acquisition. This set of rules can be kept in the overlay function and can be uploaded to the network or downloaded to the terminal memory (or R-UIM/SIM) through an OTA managing method. Consider in FIG. 4, the mobile equipment ME arriving in the second region Region 2 where the CDMA network NW3 causes a base station BTS to transmit a broadcast message 40 identifying the system and network data to all users in the region; in the case of CDMA these are SID/NID pairs for the available CDMA systems. In GSM networks, the base station transmits beacon frequencies, and the mobile equipment evaluates the signal strength of any beacon frequencies to locate the preferred GSM system. The overlay function receives this data via the radio software component 24 and identifies the preferred access technology and system according to its algorithms and the parameters in the parameter block 22. The mobile equipment ME can access the PRL corresponding to the preferred access technology, and can then scan that PRL block for channel acquisition. This is faster than using a single large preferred roaming list which combines parameters for all of the possible access technologies.

Management of access technology selection is carried out in the following way. Effective roaming requires up-to-date management of the PRLs, parameter block and overlay function block when carrier and user preferences change.

Management is effected using a management server (MS) in the network. FIG. 4 shows schematically part of the architecture of a UMTS (Universal Mobile Telecommunications Network). This shows an RNC (Radio Network Controller); and SGSN (Serving GPRS Support Node); a GGSN (Gateway GPRS Support Node); a management server (MS); and the Internet. In FIG. 4 the management server MS is directly connected to an operator's GORS domain via the GGSN. In an alternative embodiment, the management server may be connected to an operator's GGSN through the Internet.

As explained above, the PRL initially provisioned in the home network enables the mobile equipment ME to select an initial preferred access technology for the region where it is located. After the preferred access technology has been selected, the device information tree 28 at the mobile equipment ME is updated with the “current mode” parameter <cmp>. As illustrated in FIG. 5, a notification message 42 is sent according to a communication mode using the selected access technology from the OTA management client 26 in the mobile equipment ME to the management server MS in the geographical region where the mobile equipment is now located, the notification message 42 including current mode parameters <cmp> and other parameters identifying the user/equipment identity and subscribed service of the specific user. Based on this information, the management server MS sends an update message 24 back to the mobile equipment to update one or all of the preferred roaming list stored in the memory 2, the parameter block 22 or the multimode overlay function block 20.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes, in form and shape, may be made therein without departing from the scope and spirit to the invention as set forth above.

1. A mobile device for roaming between wireless communications networks in different geographical regions, the mobile device comprising:
a radio interface configured to receive network data over a wireless channel, said data relating to one or more of a plurality of access technologies available in a geographical region;
a first store holding channel acquisition data relating to each of said plurality of access technologies for setting up a communication mode in a selected one of said access technologies;
a second store holding a plurality of access technology selection parameters; and
a multimode overlay function component configured to evaluate said data and select one of said access technologies based on at least one of said selection parameters.

2. A mobile device according to claim 1, wherein the multimode overlay function component is implemented as a software module.

3. A mobile device according to claim 1, wherein the radio interface comprises operating software, and wherein the multimode overlay function component is implemented in said operating software.

4. A mobile device according to claim 1, wherein the multimode overlay function component comprises at least one algorithm for evaluating said data and selecting one of said access technologies.

5. A mobile device according to claim 4, wherein said algorithm comprises a set of rules.

6. A mobile device according to claim 1, wherein the access technology selection parameters held in said second store are updateable over the air.

7. A mobile device according to claim 4, wherein the algorithm is updateable over the air.

8. A mobile device according to claim 1, wherein at least one of said access technology selection parameters comprises a threshold to determine a time to switch between access technologies.

9. A mobile device according to claim 1, wherein the plurality of access technologies include CDMA, GSM and WLAN.

10. A mobile device according to claim 1, wherein the multimode overlay function component is located in a SIM/R-UIM card.

11. A mobile device according to claim 1, wherein the second store is located in a SIM/R-UIM card or future smart cards.

12. A mobile device according to claim 1, wherein the channel acquisition data is held in the form of a preferred roaming lists or preferred network list for each access technology following respective standards.

13. A mobile device according to claim 1, wherein the radio interface is configured to use the channel acquisition data of a selected one of the access technologies to set up the communication mode.

14. A mobile device according to claim 1, wherein the first store is held in an SIM/R-UIM card or future smart cards.

15. A method of selecting a communication mode for a mobile device roaming between wireless communications networks in different geographical regions, the method comprising:
receiving network data identifying wireless communications networks in a region where the mobile device is located;
accessing at least one access technology selection parameter stored at the mobile device;
implementing at the mobile device a multimode overlay function to select one of a plurality of access technologies based on said at least one access technology selection parameter and said network data; and
scanning channel or network acquisition data for the selected access technology to set up a communication mode using the selected access technology.

16. A method of managing access technology selection in a mobile device capable of transmitting and receiving signals using each of a plurality of access technologies, the method comprising:
transmitting a notification message from a mobile device to a management server, said notification message including parameters identifying the device and an access technology of a current communication mode; and
transmitting an update message from the management server to the mobile device according to said communication mode, for performing an update to at least one access technology selection parameter stored at the mobile device.

17. A method of managing an access technology selection in a mobile device capable of transmitting and receiving signals using each of a plurality of access technologies, the method comprising:
transmitting a notification message from a mobile device to a management server, said notification message including parameters identifying the device and an access technology of a current communication mode; and
transmitting an update message from the management server to the mobile device according to said communication mode, for performing an update to at least one algorithm implemented in a multimode overlay function component stored at the mobile device.

18. The method according to claim 16, wherein transmitting the notification message and the update message are implemented according to open mobile alliance device management protocol.

19. The method according to claim 16, wherein transmitting the notification message and the update message are based on over-the-protocol, such as OTASP/OTAPA, OMA DM, 3GPP2IOTA-DM/HCM or similar protocols used to manage mobile devices over-the-air.

20. The method according to claim 16, wherein transmitting the notification message and the update message are based on over-the-air service provisioning/parameter administration protocol.

21. The method according to claim 16, wherein transmitting the notification message and the update message are based on air interface messaging.

22. The method according to claim 16, wherein transmitting the notification message and the update message are implemented in XML-based protocols, such as (but not limited to) OMA DM, 3GPP2 IOTA-DM/HCM.

23. The method according to claim 16, wherein transmitting the notification message and the update message are implemented according to SMS-based protocols.

24. The method according to claim 16, wherein transmitting the notification message is instigated by a user of the mobile device.

25. The method according to claim 16, wherein transmitting the update message is instigated by the management server.

26. A computer program product comprising a code sequence which, when executed by a processor in a mobile device, causes the device to:
receive network data identifying wireless communications networks in a region where the mobile device is located; accessing at least one access technology selection parameter stored at the mobile device; and
implement an access technology selection algorithm for selecting one of a plurality of access technologies based on said at least one access technology selection parameter and said network data.
